(19) United States
(12) Patent Application Publication
(10) Pub. No.: US 2007/0292240 A1
(43) Pub. Date: Dec. 20, 2007

(54) Wall anchor device for frame

(76) Inventor: Mark S. Rodder, Dallas, TX (US)

Correspondence Address: SMITH IP SERVICES, P.C., P.O. Box 997, Rockwall, TX, 75087, US

(21) Appl. No.: 11/443,333

(22) Filed: May 30, 2006

(51) Int. Cl. F16B 15/02

(52) U.S. Cl. 411/480

(57) ABSTRACT

An anchor device for securing an object to a wall includes a body having first and second opposite facing surfaces, an adhesive material on the first surface, a pointed fastener extending outwardly from the second surface, and a protective cover positioned over a pointed end of the fastener. A center axis of the fastener may be laterally offset from a center axis of the body by an offset distance which is one-half to three quarters of a distance between the body center axis and a side edge of the body.

### BACKGROUND

The present invention relates generally to devices used for mounting objects on surfaces such as walls and, in an embodiment described herein, more particularly provides a wall anchor device for securing a frame to a wall.

Frames and other objects are typically mounted on walls or other surfaces by suspending them from fasteners or hooks. For example, a frame may be provided with a wire, a loop or a notched strip, which will be placed on a fastener or hook previously secured to a wall. This allows the frame to be pivoted on the fastener or hook to the left or right as needed to level the frame.

Unfortunately, the frame rarely remains level, no matter how much care is taken to balance the frame on the fastener or hook. When a loop is used on the frame, the loop might not be positioned precisely at the center of mass of the frame. When a notched strip is used on the frame, the notches are only provided at discrete positions, none of which may be aligned with the center of mass of the frame. When a wire is used on the frame, it is very difficult to position the fastener or hook along the wire so that the fastener or hook is accurately aligned with the frame center of mass.

Even in the rare circumstance where the frame is suspended at its center of mass, it can still become askew. For example, vibration, a person brushing against the frame, etc. can cause the frame to tilt to one side.

Therefore, it may be seen that improvements are needed in the art of securing frames and other objects to walls. One purpose of the present invention is to provide such improvements.

### SUMMARY

In carrying out the principles of the present invention, a wall anchor device is provided which solves at least one problem in the art. One example is described below in which the device is used to anchor a frame to a wall, so that the frame remains level after installation. Another example is described below in which the anchor is provided with features which protect the wall during installation.

In one aspect of the invention, a wall anchor device for securing an object to a wall is provided. The device includes a body having opposite facing surfaces. A pointed fastener extends outwardly from one of the surfaces. A center axis of the fastener may be laterally offset relative to a center axis of the body. In one example, the center axis of the fastener is laterally offset from the center axis of the body by an offset distance which is one-half to three quarters of a distance between the body center axis and a side edge of the body.

In another aspect of the invention, a wall anchor device is provided which includes a body having opposite facing surfaces, an adhesive material on one of the surfaces, a pointed fastener extending outwardly from the other surface, and a protective cover positioned over a pointed end of the fastener.

These and other features, advantages, benefits and objects of the present invention will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is a schematic cross-sectional view of a wall anchor device embodying principles of the present invention;

FIG. 2 is a schematic cross-sectional view of an alternate construction of the wall anchor device embodying principles of the present invention;

FIG. 3 is a schematic elevational view of the wall anchor device in use with a frame; and

FIG. 4 is a schematic cross-sectional view of the wall anchor device with a protective cover of the device pierced by a fastener of the device to anchor the frame to a wall.

### DETAILED DESCRIPTION

It is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments. In the following description of the representative embodiments of the invention, directional terms, such as “above”, “below”. “upper”, “lower”, etc., are used for convenience in referring to the accompanying drawings.

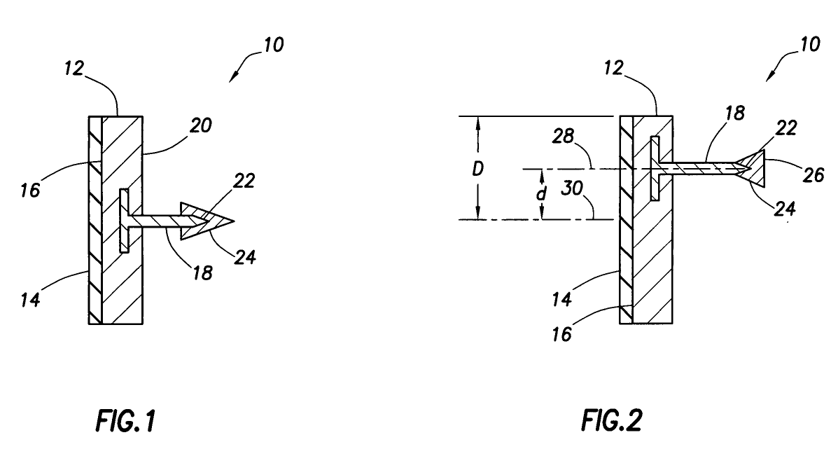

Representatively illustrated in FIG. 1 is a wall anchor device 10 which embodies principles of the present invention. The device 10 may be used to secure frames and other objects to walls and other surfaces. Preferably, the device 10 is first attached to the object, then the object is suspended from a fastener, hook or other suspension device on a wall, the object is leveled or otherwise appropriately positioned, and then the device 10 is used to anchor the object in its position on the wall.

For this purpose, the device 10 includes a generally flat disc-shaped body 12, an adhesive material 14 on one surface 16 of the body, and a pointed fastener 18 extending outwardly from an opposite surface 20 of the body. The adhesive material 14 is used to attach the device 10 to a side of the object which will face toward the wall. When the device 10 is attached to the object, a pointed wall-piercing end 22 of the fastener 18 will, thus, extend toward the wall.

The adhesive material 14 may be initially covered with a backing or cover which is removed prior to attaching the device 10 to the object. Any type of material suitable for adhesively attaching the device 10 to the object may be used for the adhesive material 14 in keeping with the principles of the invention. It is not necessary for the adhesive material 14 to be attached to the body 12 prior to attaching the device 10 to the object.

To protect the wall from the pointed end 22 of the fastener 18 while the object is being positioned on the wall, a protective cover 24 is used to isolate the wall from the fastener. The cover 24 may be made of a non-marring material (such as plastic, rubber, etc.), which will not scratch or otherwise damage the wall as the object is repositioned on the wall.

As depicted in FIG. 1, the cover 24 has a conical shape. This shape serves to efficiently cover the pointed end 22 of the fastener 18, while providing some desirable resistance to movement of the object across the wall when the cover 24 is in contact with the wall. However, it should be understood that the cover 24 may have any shape in keeping with the principles of the invention.

In FIG. 2, the device 10 is representatively illustrated in an alternate configuration in which the cover 24 has a frusto-conical shape. This shape provides a generally flat planar wall-engaging surface 26 which is even less likely to damage the wall as the object is repositioned on the wall. The surface 26 also provides less resistance to movement of the object across the wall when the cover 24 is in contact with the wall.

Another difference between the configurations of the device 10 in FIGS. 1 & 2 is that, in the configuration of FIG. 2, a center axis 28 of the fastener 18 is laterally offset relative to a center axis 30 of the body 12. Preferably, the center axis 28 of the fastener 18 is offset from the center axis 30 of the body 12 by an offset distance d which is one-half to three quarters of a distance D between the body center axis and a side edge of the body.

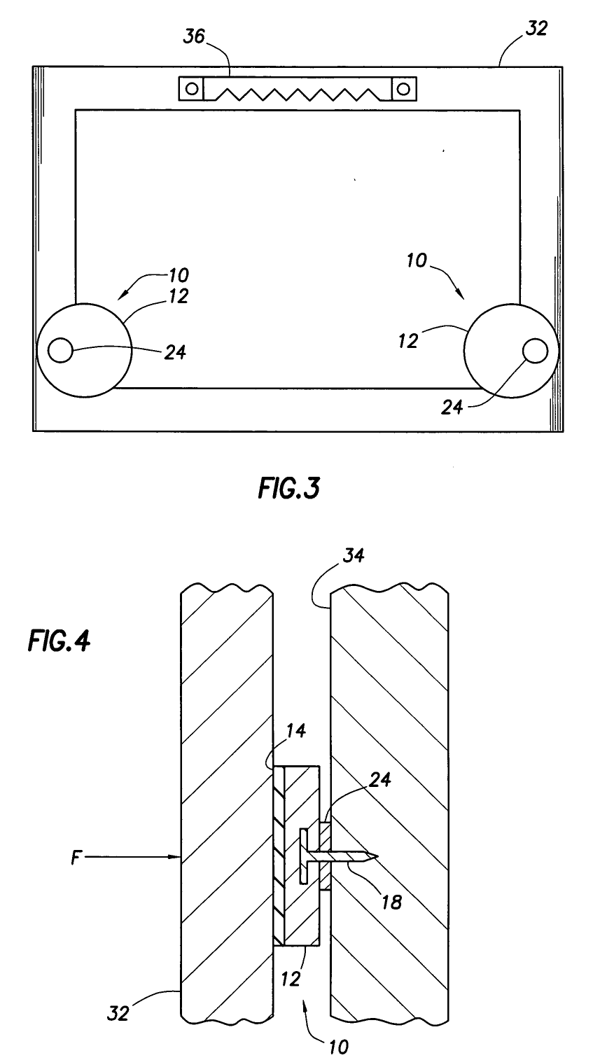

An advantage provided by this offset of the fastener 18 relative to the body 12 is representatively illustrated in FIG. 3. In this view, two of the devices 10 have been attached near lower rear corners of a frame 32 using the adhesive material 14. The width of the frame 32 is not large enough to accommodate the entire width of the body 12 but, due to the offset of the fastener 18 relative to the body, the fastener can still be positioned behind a solid portion of the frame.

The positioning of the fastener 18 behind a solid portion of the frame 32 is important because, after the frame is appropriately positioned on the wall, a predetermined force is applied via the frame to cause the fastener to pierce the wall.

In FIG. 4, a side cross-sectional view is representatively illustrated, in which a predetermined force F is applied to a front of the frame 32. The force F is transmitted through the frame 32 to the device 10, thereby causing the fastener 18 to penetrate the cover 24 and pierce a surface or wall 34.

In this manner, the frame 32 is anchored to the wall 34 in a desired position (e.g., level) and, even though circumstances (such as not being suspended at its center of mass, vibration, etc.) might tend to cause the frame to move out of this position, the device 10 will prevent such movement. The fastener 18 only pierces the wall 34 behind the frame 32, and so this is hidden from view.

The force F is applied only after the frame 32 is suspended on the wall 34 (for example, via a notched strip 36 or other type of suspension device), and the frame is appropriately positioned on the wall. Thus, the device 10 is used primarily not to suspend the frame 32 from the wall 34, but to maintain a desired position of the frame on the wall after the frame has been suspended and the desired position has been achieved.

As described above, the cover 24 is preferably made of a non-marring material. The cover 24 is also preferably constructed with appropriate material, thickness, etc., so that the fastener 18 will be able to penetrate the cover when the predetermined force F is applied.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. An anchor device for securing an object to a wall, the device comprising:
a body having first and second opposite facing surfaces;
an adhesive material on the first surface;
a pointed fastener extending outwardly from the second surface; and
a protective cover positioned over a pointed end of the fastener.

2. The anchor device of claim 1, wherein the cover is operative to protect the wall from the pointed end of the fastener until the cover is pierced by the fastener.

3. The anchor device of claim 1, wherein the cover is operative to protect the wall from the pointed end of the fastener until a predetermined force is applied to the body.

4. The anchor device of claim 1, wherein the protective cover has a generally conical wall-engaging end.

5. The anchor device of claim 1, wherein the protective cover has a generally planar wall-engaging surface.

6. The anchor device of claim 1, wherein the protective cover has a generally frusto-conical shape.

7. The anchor device of claim 1, wherein a center axis of the fastener is laterally offset relative to a center axis of the body.

8. The anchor device of claim 1, wherein a center axis of the fastener is laterally offset from a center axis of the body by an offset distance which is one-half to three quarters of a distance between the body center axis and a side edge of the body.

9. An anchor device for securing an object to a wall, the device comprising:
a body having first and second opposite facing surfaces; and
a pointed fastener extending outwardly from the second surface, a center axis of the fastener being laterally offset relative to a center axis of the body.

10. The anchor device of claim 9, wherein the center axis of the fastener is laterally offset from the center axis of the body by an offset distance which is one-half to three quarters of a distance between the body center axis and a side edge of the body.

11. The anchor device of claim 9, further comprising an adhesive material on the first surface.

12. The anchor device of claim 9, further comprising a protective cover positioned over a pointed end of the fastener.

13. The anchor device of claim 12, wherein the cover is operative to protect the wall from the pointed end of the fastener until the cover is pierced by the fastener.

14. The anchor device of claim 12, wherein the cover is operative to protect the wall from the pointed end of the fastener until a predetermined force is applied to the body.

15. The anchor device of claim 12, wherein the protective cover has a generally conical wall-engaging end.

16. The anchor device of claim 12, wherein the protective cover has a generally planar wall-engaging surface.

17. The anchor device of claim 12, wherein the protective cover has a generally frusto-conical shape.

18. An anchor device for securing an object to a wall, the device comprising:
a body having first and second opposite facing surfaces;
an adhesive material on the first surface;
a pointed fastener extending outwardly from the second surface, a center axis of the fastener being laterally offset from a center axis of the body by an offset distance which is one-half to three quarters of a distance between the body center axis and a side edge of the body; and
a protective cover positioned over a pointed end of the fastener.

19. The anchor device of claim 18, wherein the cover is operative to protect the wall from the pointed end of the fastener until the cover is pierced by the fastener.

20. The anchor device of claim 18, wherein the cover is operative to protect the wall from the pointed end of the fastener until a predetermined force is applied to the body.
